(19) United States
(12) Patent Application Publication
(10) Pub. No.: US 2012/0019195 A1
(43) Pub. Date: Jan. 26, 2012

(54) MODULAR ENERGY ACCUMULATION AND STORAGE SYSTEM

(76) Inventor: Francois Gagnon, Montreal (CA)

(21) Appl. No.: 12/840,997

(22) Filed: Jul. 21, 2010

(51) Int. Cl. H02J 7/00; H01M 10/48

(52) U.S. Cl. 320/107; 429/92

(57) ABSTRACT

The present invention is an energy accumulation and storage system which improves the harnessing of energy, specifically electrical energy, from low efficiency or intermittent energy sources and allows for the rapid transfer of such harnessed energy to mobile battery operated applications such as automobiles, lawn mowers, and other vehicle types.

The present invention also incorporates an energy management system capable of maximizing the efficiency of the collection, storage and use of energy.

### FIELD OF THE INVENTION

The present invention relates to a modular energy accumulation and storage system. More specifically, the present invention is concerned with the storage of electricity harvested from various sources on modular storage devices capable of being employed in different battery operated applications.

### BACKGROUND OF THE INVENTION

There exists a multitude of electric accumulators adapted for many types of applications ranging from wrist watches to electric lift trucks. However, none of these electric accumulators favour a more efficient and responsible management of energy, and even fewer are adapted to harness alternative energy sources. Solar panels are a source of intermittent energy but require an efficient energy accumulation system. Similarly, wind turbines are a source of intermittent and variable energy which also require an efficient energy accumulation system. As a result, the lack of efficient electric accumulator systems greatly deters the harnessing of environmentally friendly energy sources, principally those energy sources that have low efficiency or intermittent outputs of electricity.

### SUMMARY OF THE INVENTION

The present invention is an energy accumulation and storage system which improves the harnessing of energy, specifically electrical energy, from low efficiency or intermittent energy sources and allows for the rapid transfer of such harnessed energy to mobile battery operated applications such as automobiles, lawn mowers, and other vehicle types. The present invention also incorporates an energy management system capable of maximizing the efficiency of the collection, storage and use of energy.

The present invention possesses numerous benefits and advantages.

For example, a household having a small house and an automobile consumes between $2,000 and $5,000 of energy annually. Through the investment of $50,000 to $100,000 in an energy management system and the purchase one or two sources of green energy, a household could reduce this cost by 50% to 100%. In addition to being economically justifiable, a decision to deploy an energy management system will be environmentally responsible. With regards to a manufacturing enterprise, the investment in an energy management system promoting the production and management of clean energy translates into immediate energy savings for the enterprise, as well as a potential return on investment once carbon exchange markets are established.

Furthermore, the present invention solves the immediate problem associated with battery cells currently found in electric cars. The modular energy accumulation and storage system permits an automobile's batteries to be recharged in 3 to 4 minutes through the simple exchange of energy accumulation units. Existing service stations would not have to undergo a major transformation to offer these energy accumulation units exchange services.

The modular energy system is also not limited to one type of battery cell technology. Diverse types of battery cells made of various compositions can be used jointly as a result of individual identification microchips integrated into energy accumulation units. For example, a household can be equipped with 50 high performance cells which are mainly utilised for their vehicle and 100 low performance but less expensive cells which are used for other domestic needs. This versatility would allow new types of cell technology to easily be integrated into the market and favours, among other things, the diversification of first developers of this energy management system.

Yet another advantage of the present invention would be the benefit derived by the electric utilities. When 20% to 30% of an electric utility's clients are equipped with an energy management system, a simple modification of the electricity rate at peak hours would permit the increase in the availability of electricity for 15% to 25% more clients using the same utility resources.

We have herein below described in detail a modular energy accumulation and a software management system that accompanies it.

More specifically, there is provided a decentralised energy management system consisting of small standardized energy accumulation units which can be easily manipulated, installed, and exchanged by a user. Electricity is harnessed from various energy sources and is stored in energy accumulation units located in houses, businesses, and factories. A software energy management system controls the charging of the energy accumulation units.

The principal objectives of this invention are thus as follows. Firstly, the development of a standard electrical energy accumulation unit capable of being utilized as a portable and modular power source in a wide variety of applications. Secondly, the creation of an energy management software program for the optimization of the accumulation of energy from diverse energy sources and the storage of such accumulated energy in a group of standard energy accumulation units. Thirdly, the utilization of these energy accumulators to quickly recharge electrical vehicles by swapping spent electrical energy accumulation units from a vehicle with recharged electrical energy accumulation units to thus provide such vehicles the same autonomy as those having combustion engines.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 is a partial cross-sectional side view of a modular energy accumulation unit;

FIG. 2 is a cross-sectional view of a modular energy accumulation unit;

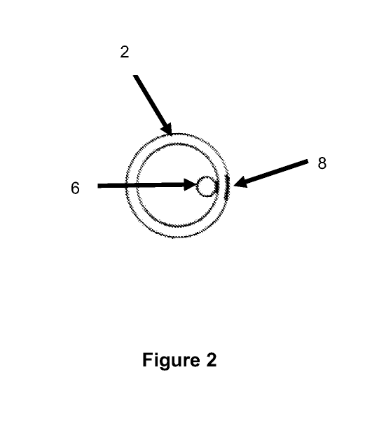

FIG. 3 is an overview of a modular energy accumulation and storage system deployed in a residential household capable of accumulating and harnessing electricity from various energy sources;

FIG. 4 is a view of an electric car capable of receiving modular energy accumulation units;

FIG. 5 is a view of an electric scooter capable of receiving flexible modular energy accumulations units.

### DESCRIPTION OF EMBODIMENTS OF THE INVENTION

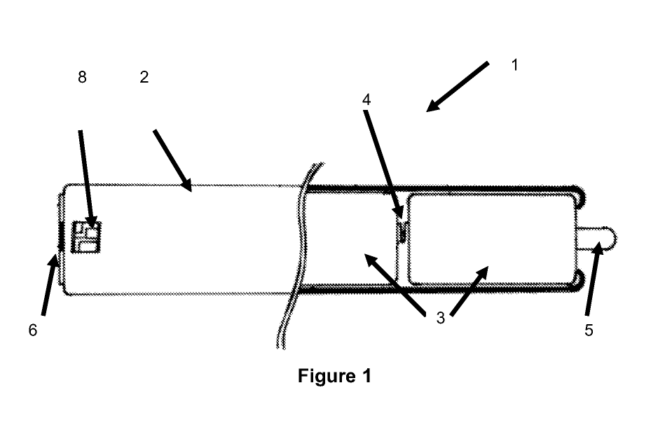

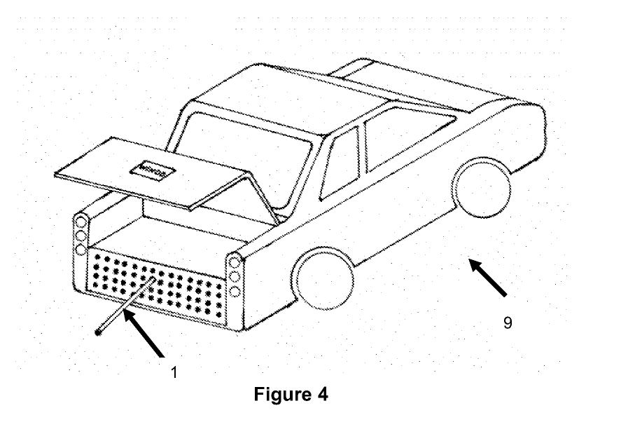

FIG. 1 illustrates a preferred design for a modular battery or energy accumulation unit 1. The energy accumulation unit 1 comprises a housing 2 made of a semi-rigid tube such that the accumulator unit is bendable; a series of battery cells 3 located within the housing 2; a conducting wire 4 which connections the battery cells 3; a first end 5 of the housing 2; a variable color coated second end 6 of the housing 2; and a microchip 8 capable of communicating the energy state of the battery to a software energy management system. The first end 5 and the second end 6 have different geometries to prevent the polarity inversion of energy accumulation units. The energy accumulation unit 1 has to be easily manipulable so that, for example, a user can rapidly exchange a series of depleted units to and from a battery operated application, such as an automobile 9 shown in FIG. 4, with different accumulation units 1 which have been previously charged by the user in his house or by a vendor at his place of business. The reader will have a good idea of the design of an energy accumulation unit 1 by imagining a series of type D electric batteries aligned in series within a plastic tube. An energy accumulation unit 1 preferably has a weight between 5 and 10 kilograms, a diameter between 50 and 75 mm and a length between 1 and 1.5 meters and generates a nominal voltage of 12 volts or more. Furthermore, the energy accumulation unit 1 permits numerous different layout configurations based on the particular application in which they are employed. The housing 2 of an energy accumulation unit 1 will therefore preferably be flexible to thus integrate the series of batteries in small, space limited applications. Finally, the voltage output of an energy accumulation unit 1 should be sufficient for one energy accumulation unit 1 to be exclusively employed as the power source for a battery operated application.

An energy accumulation unit 1 is not limited to one type of energy battery cell technology. Diverse types of battery cells of different compositions can be used jointly as a result of their individual microchips 8 capable of identifying a unit. For example, energy accumulation units 1 with high performance cells can be used in high performance applications, such as a sports car. Contrarily, energy accumulation units 1 with lower performance cells can be used in domestic or factory applications with less energy exigent energy requirements.

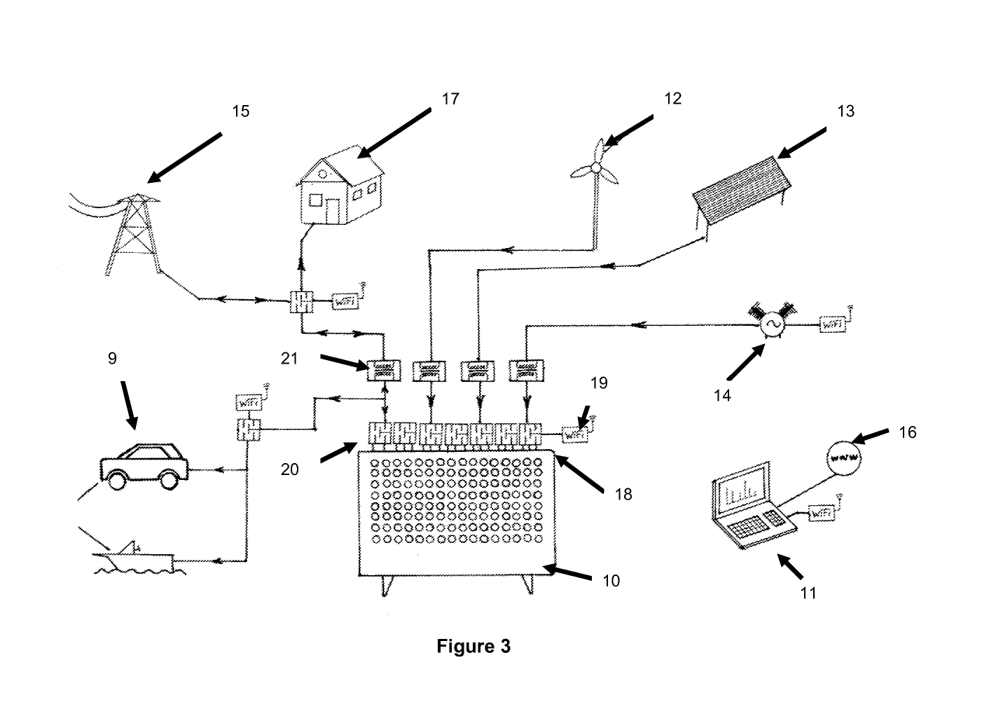

A charging box 10 (See FIG. 3) of an energy accumulation unit 1 may be constructed to facilitate the storage of energy accumulation units 1. A slight separation between energy accumulation units 1 when stored in the charging box 10 permits the necessary diffusion of heat produced through charging of the least efficient energy accumulation units 1.

The state of an energy accumulation unit 1 is instantaneously determinable by the user. Each energy accumulation unit 1 has a microchip 8 which has a dual role of communicating the state of the battery to the energy management system as well as to the user. To represent the charge state of an energy accumulation unit 1, the second end 6 of the unit is capable of altering colors to represent charge states. For example, the second end 6 would indicate the color green to represent a fully charged energy accumulation unit 1; the color yellow would represent a partially charged energy accumulation unit 1; and a red color would represent an energy accumulation unit 1 without a useful charge. Black would represent an aging energy accumulation unit 1 that should be recycled.

The design of the energy management system, that is installable on a computer 11 (See FIG. 3), is an additional component of the system for an optimal harnessing of multiple energy sources and deployment of energy unit accumulators. Such an energy management system individually manages each energy accumulation unit 1 in order to optimise the number of units fully available for an application and to maximise the reduction of the cost of used energy. More specifically, the energy management software can: simultaneously recharge a minimum number of energy accumulation units 1 in order to maximise the number of units available that are fully charged if a transfer is required; continuously calculate usage rate of each individual sources of energy and optimise the demand to reduce the cost price and; utilise a minimum battery power to generate the instantaneous power required. For example, a household 17 could harness energy from five different sources to satisfy its needs. A small wind turbine 12, several square meters of solar paneling 13, an exercise bicycle with a dynamo as resistance, a small emergency generator 14 and a local electricity utility 15 offering a daily rate and reduced nightly rate are examples of different energy sources. The energy management system is interfaced with the local meteorological agency over a wide area network 16 thus permitting the system to evaluate the energy that will be drawn from the wind turbine 12 and the solar paneling 13 in the forth coming days. The energy management system can also evaluate a user's electricity consumption rate to extrapolate the household heating or cooling, transportation or domestic needs for the forthcoming days. Finally, a user can require specific energy demands from the energy management system. For example, a user may require 30 fully charged energy accumulation units 1 for a camping trip in the upcoming weekend. The energy management system will capture the energy from energy sources and charge the necessary energy accumulation units 1. The system can thus decide to purchase from local electricity utility 15 and can do so at night to benefit from a reduced electricity rate. The energy management system will also be tasked to divert input and utilisation of energy for each energy accumulation unit 1. For example, the energy management system would not assign an energy accumulation unit 1 in charging mode. It would also separate the sources of variable energy from the fixed sources to avoid the overvoltage during charging, and regulate the energy accumulation units' 1 rates of utilisation in order to maximise their life expectancies.

The vehicles utilizing energy accumulation units 1 may also have their own energy management systems. An automobile with permanently integrated energy accumulation units 1, for example, could be connected directly to the local grid power, but could also be interfaced with the household's power grid.

FIG. 3 shows the diverse connections of a modular energy accumulation and storage system employed in a residential household 17. In operation, the energy requirements and parameters are determined by the user and registered with the energy management software system installed onto a household computer 11. The energy management software system gathers information needed to determine the various input and output levels of electrical energy. It acquires the local weather forecast accessed via the wide area network 16 and obtains the variations in the electricity rate from the local electricity utility 15. Once the system has determined the available energy needs and the most efficient acquisition of energy from the various available energy sources, diverse harnessing control switches 18 are activated by Wi-Fi relays 19. A module of electric contacts 20 ensures the correct coupling of energy inputs and outputs with the goal of maximising the efficiency and the life of the energy accumulation units 1 housed in charging box 10. Specialized transformers 21 ensure the compatibility between the multiple energy accumulation units 1 and the diverse energy sources 12, 13, 14, 15. When employed in combination with the energy accumulation system, a very small generator 14 can sufficiently provide for the entire needs of a household 17.

The modular energy accumulation and energy system can be used for many different applications such as household's energy needs and battery operated transportation applications.

Normally, households consume energy in the form offered by the public utilities. The energy management system selects the most efficient energy source from which to draw energy from and supply the household 17 with. If the alternative forms of energy supplied by the wind turbine 12 and solar paneling 13 are not sufficient to satisfy household demand, the energy management system opts, if possible, to purchase energy from the local electricity utility 15 during the reduced electric rate periods. The energy management system can even decide to accumulate energy during reduced electric rate periods and to resell it during peak periods, if the local electricity utility 15 rates permit. If the local electricity utility 15 has a policy of buying and selling electricity at different rates during the peak hours, the ability for the energy management software system to buy electricity during low demand periods and then sell stored electricity back the local electricity utility 15 during high demand periods could expand the flexibility of the utility with regards to the global availability of network power during peak periods.

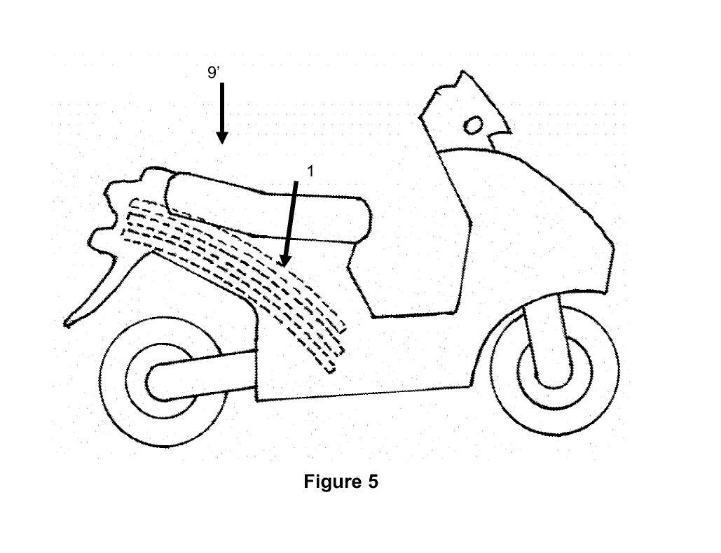

The modular energy accumulation system could also be deployed as an energy source in the transportation sector. For example, energy accumulation units 1 can be employed in motorised bicycles, electric scooters, automobiles, and large vehicles. A bicycle with a motorised wheel would utilise 2 to 4 accumulators. An electric scooter would utilise 6 to 12 accumulators. FIG. 5 demonstrates how flexible energy accumulation units 1 would be advantageously used in an application, such as in an electric scooter 9′ where storage space for an accumulator would be restricted due to the geometry of a vehicle. A motorcycle would utilise 12 to 24 accumulators. An automobile would utilise 30 to 120 accumulators in function with the size of the vehicle and power desired. FIG. 4 in particular shows an automobile 9 in which the energy accumulation units 1 are received via the rear of the vehicle. Other automobile designs could favour a frontal or lateral loading of units. An automobile can be constructed to receive 125 energy accumulation units 1 but only be operated with 25 units if it is only used for short distances. In such a scenario, a reduction of 700 or 800 kilograms equivalent to the other 100 units would permit a significant energy savings. Other transportation applications could further include a small delivery truck which would utilise 50 to 200 batteries. Also an urban bus could use 200 to 500 batteries, but a design adapted to heavy vehicles should be envisioned.

The replacement of an energy accumulation unit 1 used in a battery operated application is described as follows. Users can recharge spent energy accumulation units 1 in several ways: via a transfer of standardized energy accumulator units 1 from a charging box 10; via a connection of a battery operated application having permanently integrated energy accumulation units 1 to the a charging box 10 such that the energy management software system is able to charge the battery operated application either with energy held in reserve in other energy accumulation units 1, with energy harnessed outside peak hours from of the local electricity utility 15, with energy drawn energy from the local electricity utility 15, or with energy collected from a combination of preceding solutions in order to minimize costs. For larger battery operated applications, such as large vehicles, these can be recharged in two ways: a slow charge via a connection to a charging box 10 or to the local electricity utility 15; or when a rapid charge of a vehicle is required, via a manual exchange of energy accumulation units 1 housed within the larger vehicle.

Although the present invention has been described hereinabove by way of embodiments thereof, it may be modified, without departing from the nature and teachings of the subject invention as defined in the appended claims.

1. A modular energy accumulation unit comprising:
at least one battery cell;
a housing for receiving the at least one battery cell;
a microchip connectable to the at least one battery cell; and
a display connectable to the at least one microchip;
wherein said microchip evaluates a charge level of the at least one battery cell when positioned in the housing and indicates the charge level on the display and communicates the charge level, the capability and identification of the said modular energy accumulation unit to an energy management system.

2. The modular energy accumulation unit according to claim 1, wherein the display comprises a variable display (such as a colour display).

3. The modular energy accumulation unit according to claim 1 or 2, wherein the housing is a flexible tubular housing.

4. The modular energy accumulation unit according to any one of claims 1 to 3, wherein the at least one battery cell comprises at least two battery cells connected in series.

5. The modular energy accumulation unit according to any one of claims 1 to 4, wherein the said modular energy accumulation unit is used to power a transportation vehicle.

6. A modular accumulation and storage system of electric energy harnessed from multiple energy sources comprising:
a charger;
at least one energy accumulation unit;
an energy management system;
wherein the energy management system is capable of selectively charging the said energy accumulation units using electricity harnessed from said multiple energy sources.

7. The modular accumulation and storage system according to claim 6, wherein the said modular energy accumulation unit is used to power a transportation vehicle.
